(19) United States
(12) Patent Application Publication
(10) Pub. No.: US 2008/0071688 A1
(43) Pub. Date: Mar. 20, 2008

(54) Apparatus, system and method for the management of digital rights managed (DRM) licenses into a user interface

(76) Inventors: Kevin Corbett, Rescue, CA (US); Brian David Johnson, Portland, OR (US); William D. Boyle, Morgan Hill, CA (US)

Correspondence Address: INTEL CORPORATION;c/o INTELLEVATE, LLC, P.O. BOX 52050, MINNEAPOLIS, MN, 55402, US

(21) Appl. No.: 11/521,999

(22) Filed: Sep. 14, 2006

(51) Int. Cl. H04L 9/00

(52) U.S. Cl. 705/59

(57) ABSTRACT

An apparatus, system and method that allow for the management of digital rights managed (DRM) licenses via a user interface. A method includes displaying a user interface on a display device, where the user interface includes a menu having one or more menu selections provided by a content and/or service provider for the management of digital rights managed (DRM) licenses, where each of the one or more menu selections represents a product offered to a user at a user side and where the menu includes a current license status for each of the products. Then, activating one of the one or more menu selections to display a DRM license menu if a license is required for the product of the activated menu selection. Finally, storing the product of the activated menu selection at the user side if a license is obtained by the user. Other embodiments are described and claimed.

### BACKGROUND

Television (TV) display user interfaces have design lay outs to receive information from a standard TV remote control. However, navigation and/or manipulation of a today's user interfaces are slow and confusing via a standard TV remote control. This is especially true with the management of digital rights managed (DRM) licenses and DRM certificates in the growth of viable intellectual property (IP) delivered business models.

### BRIEF DESCRIPTION OF THE DRAWINGS

FIG. 1 illustrates one embodiment of a user interface.

FIG. 2 illustrates one embodiment of a user interface.

FIG. 3 illustrates one embodiment of a user interface.

FIG. 4 illustrates one embodiment of a navigation controller.

FIG. 5 illustrates one embodiment of a system.

FIG. 6 illustrates one embodiment of a logic flow.

FIG. 7 illustrates one embodiment of a device.

FIG. 8 illustrates one embodiment of a data structure.

### DETAILED DESCRIPTION

Various embodiments may be generally directed to a user interface that allows for the management of digital rights managed (DRM) licenses. In one embodiment, for example, one or more content and/or service providers utilize a DRM licenses system/module to allow a user to obtain a DRM license to access their content and/or services. A user interface includes a navigation section that may provide navigation for TV content and/or service browsing. The navigation section initially displays a content and/or service provider (CSP) menu having one or more menu selections. Based on the particular menu selection that is activated, it is determined whether a content and/or service provider requires a DRM license to access the activated selection. If so, a DRM menu is displayed on the user interface that pulls the required (changeable over time) and customized fields from the DRM licenses system/module for the particular content and/or service provider. The DRM menu collects the user data and provides it to the content and/or service provider. The user is then returned to the user interface to where he or she was prior to activating the selection. In an embodiment, when the user initially takes a license to a product, the product offered by a content and/or service provider, it is downloaded locally to the user side and marked as being unlocked. When a license expires, the content and/or service provider has the choice of whether the product is automatically deleted from its local user side location, but the product is marked as being locked. If the user once again obtains a license for the locked product, the product is marked as unlocked and available to the user. The product may also be deleted from its local user side location once it is determined that the user is not going to renew the expired license. This allows for multiple content and/or service providers to aggregate DRM licensing tasks that are necessary for a worldwide content and services delivery system into a single architecture and business process. The approach affords a maximum amount of flexibility for the content and/or service provider to manage DRM licenses to its content and/or services, but does not confuse or interrupt the user's browsing or enjoyment. Other embodiments may be described and claimed.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

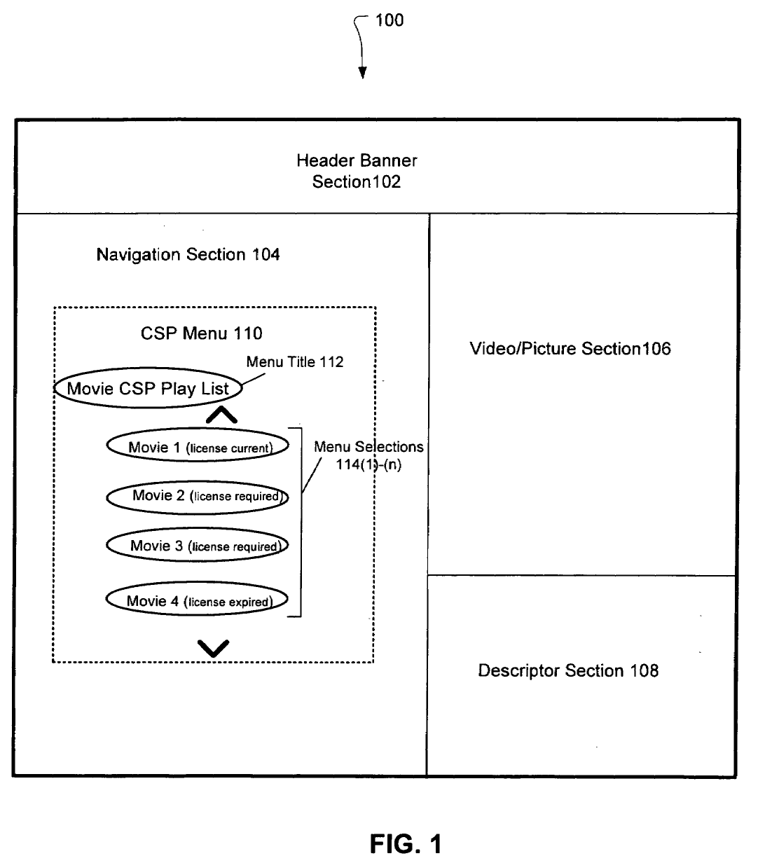

FIG. 1 illustrates one embodiment of a user interface 100. User interface 100 may comprise a header banner section 102, a navigation section 104, a video/picture section 106 and a descriptor section 108. User interface 100 may be displayed on a display device, for example. Each of these sections is described next in more detail.

Header banner section 102 may be used to display a high-level title for user interface 100. Video/Picture section 106 displays content, where the content may include shows or programs, graphics, video games, books, and so forth. In an embodiment, the content is received via one or more of broadcast, cable and satellite television feeds. Related voice, audio, music, etc., may also be presented with the displayed content in section 106. Descriptor section 108 informs the user of the content provided,in video/picture section 106. For example, descriptor section 108 may provide related guide data such as content name, channel or location (e.g., location on the Internet via an Internet Protocol (IP) address or Uniform Resource Location (URL), location on a local hard disk, etc.), type of content (e.g., broadcast, stream, download, etc.), metadata (e.g., content description, year of release, ratings information, category, etc.), air time, a brief synopsis, stars, and so forth. Again, related voice, audio, music, etc., may also be presented with the displayed content in section 108. These examples are not meant to limit the invention.

Navigation section 104 may comprise a content and/or service provider (CSP) menu 110. CSP menu 110 may provide navigation for TV content and/or service browsing. CPS menu 110 may comprise virtual keys or buttons that are used to navigate user interface 100. Referring again to FIG. 1, CPS menu 110 may comprise a menu title 112 and one or more menu selections 114(1)-(n), where n is any positive integer. Menu selections 114(1)-(n) may be expandable. In an embodiment of the invention, the menu selections are fed to user interface 100 via dynamic feed (e.g., metadata, external XML strings, etc.).

In the example user interface of FIG. 1, a content and/or service provider is providing a play list of product offerings via CPS menu 110. A product may be anything offered to a user, including but not limited to, various services and/or content, shows/programs/movies, voice, audio, music, graphics, video games, books, customer lists, and so forth. The example product illustrated in FIG. 1 is a movie product. This is not meant to limit the invention.

Referring to FIG. 1, Menu title 112 is “Movie CSP Play List”. In some embodiments, menu selections 114(1)-(n) each provide an indication of the particular movie in the CSP play list and its current DRM license status. The status indicates its availability to the user (e.g., license current—user currently has an unexpired license to the selection and thus may access it; license expired—user at some point in the past obtained a license to the selection, but the license has since expired and thus must renew the license to access the selection; license available—user has not previously obtained a license to the selection and thus must obtain a license to access the selection). In an embodiment, when the user initially takes a license to a product, the product is downloaded locally to the user side and marked as being unlocked. When a license expires, the content and/or service provider has the choice of whether the product is automatically deleted from its local user side location, but the product is marked as being locked. If the user once again obtains a license for the locked product, the product is marked as unlocked and available to the user. The product may also be deleted from its local user side location once it is determined that the user is not going to renew the expired license. Note that, although not shown in FIG. 1, CPS menu 110 may also be used to manage DRM certificates (e.g., show DRM certificates and their current statuses, and so forth). The example DRM license status types are provided for illustration purposes only and are not meant to limit the invention.

For example, menu selections 114(1)-(n) or movie selections include “Movie 1”, “Movie 2”, “Movie 3”and “Movie 4”. “Movie 1” has a license that is current (unexpired) and thus is available to the user to access. In an embodiment, “Movie 1” was downloaded and stored locally at the user's side (e.g., on a hard drive) when the user obtained the license and is marked as being unlocked.

“Movie 2” and “Movie 3” are available for the user to obtain a license. For the user to have access to “Movie 2” or “Movie 3”, the user must either purchase the movies (permanent license) or rent the movies/take a subscription to the movies (temporary license). In an embodiment, the movie(s) are not downloaded locally at the user side until a license is obtained by the user.

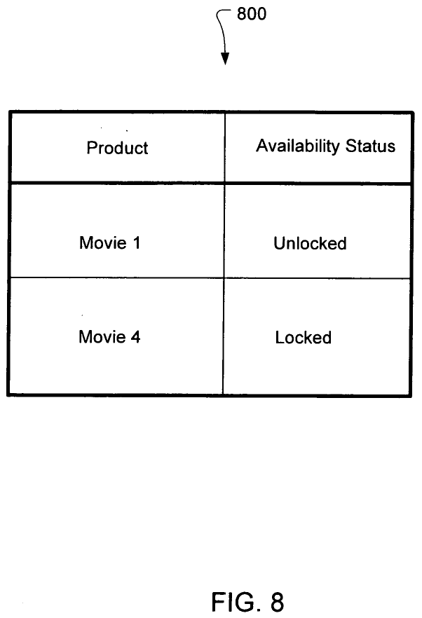

The user previously obtained a DRM license to access “Movie 4” but the license has expired, as indicated in CSP Menu 110. Here, the user must renew his license in order for him to access the movie. In an embodiment of the invention, “Movie 4” was previously downloaded locally at the user side and was not automatically deleted when the license expired. “Movie 4” is marked as being locked and thus is not accessible to the user without renewing his license. If the user decides not to renew the license, then eventually “Movie 4” may be deleted from the local user side. FIG. 8 illustrates a table 800 that may also be stored locally at the user side and updated to reflect whether the locally stored product is accessible to the user. The data structure illustrated in FIG. 8 is provided for illustration purposes only and is not meant to limit the invention. The example movie selections and associated license statuses are provided for illustration purposes only and are not meant to limit the invention.

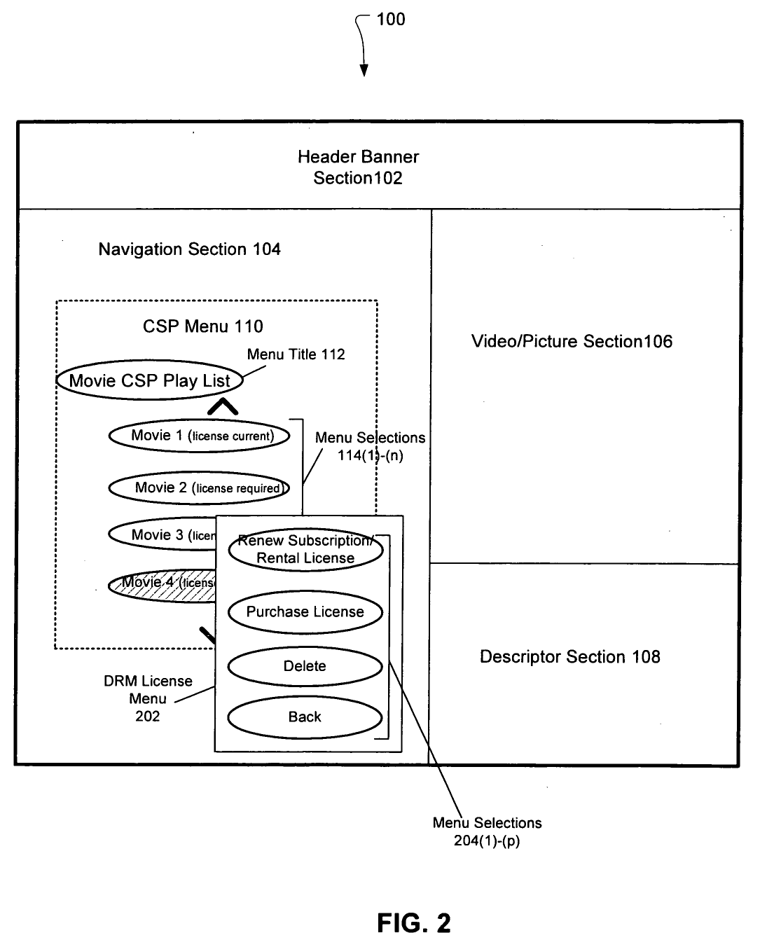

One or more of menu selections 114(1)-(n) may be activated when the user decides to access a movie. If it is determined that the content and/or service provider requires the user to take a license to the movie in order for the user to access the activated movie, then a DRM license menu may be displayed over CSP menu 110. In some embodiments of the invention, the DRM license menu is displayed partially over CSP menu 110. An embodiment of a DRM license menu is illustrated in FIG. 2.

As illustrated in FIG. 2, menu selection or “Movie 4” was activated. In an embodiment of the invention, when menu selection “Movie 4” is activated, it is determined whether a content and/or service provider requires the user to obtain a license to access the activated selection. If so, a DRM license menu 202 may be displayed on user interface 100. DRM license menu 202 pulls the required and customized fields from the DRM license system/module for the particular content and/or service provider. DRM license menu 202 collects the user data and provides it to the content and/or service provider. The user is then returned to the user interface to where he was prior to activating the selection. This example embodiment is provided for illustration purposes only and is not meant to limit the invention.

As illustrated in FIG. 2, DRM license menu 202 may include one or more menu selections 204(1)-(p), where p is any positive integer. Menu selections 204(1)-(p) may be expandable. In an embodiment of the invention, the menu selections are fed to user interface 100 via dynamic feed (e.g., metadata, external XML strings, etc.). The menu selections of DRM license menu 202 may be tailored for the license status of the activated selection, such that it includes only relevant virtual keys. For example, referring to FIG. 2, the license status of “Movie 4” is expired. Thus, menu selections 204 (1)-(p) may include the options to renew the subscription/rental license, purchase a license, delete “Movie 4” from CSP menu 110 and exit out of menu 202. This flexible approach to digital rights management of one or more products provides a simplified user experienced as well as the freedom to easily and dynamically localize and update on-screen digital rights management when needed. In addition, this flexible approach also enables multiple and various business models to facilitate the selling, advertising, providing purchase or subscription incentive and granting and management of DRM licenses. In some embodiments, CSP menu 110 and DRM License menu 202 may also facilitate the entry of data in any language.

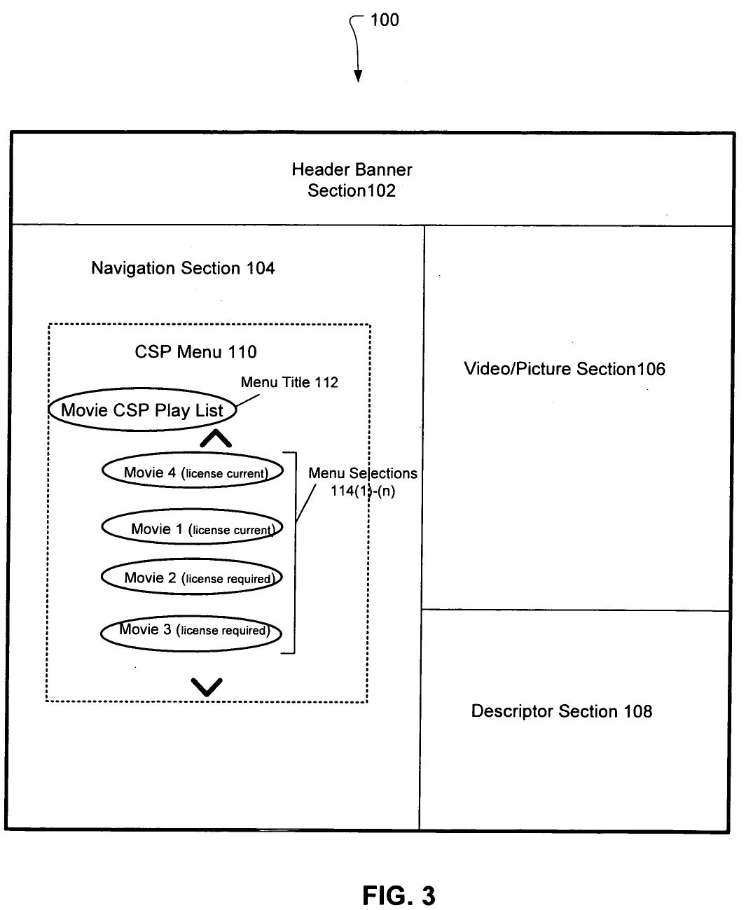

These examples are provided for illustration purposes only and are not meant to limit the invention. In some embodiments, menu selections 114(1)-(n) of CSP menu 110 may be ordered or updated in an attempt to keep the menu selection most likely to be activated by the user on top. An example embodiment is illustrated in FIG. 3. Assuming the user renewed the license to “Movie 4”, menu 110 may be updated to not only reflect the current status of the license for “Movie 4” but also reorder the menu selections such that “Movie 4” is now the first selection listed in CSP Menu 110.

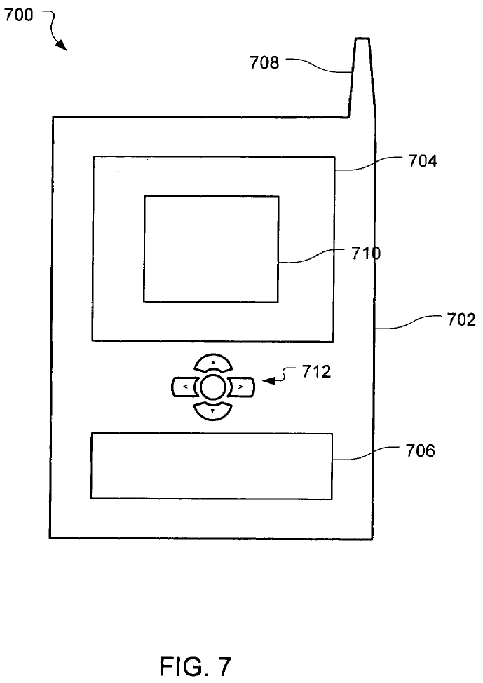

The virtual keys of CSP menu 110 and DRM license menu 202 may comprise one or more indicia thereon. The virtual keys may comprise any type of indicia to represent any type of information. The indicia may comprise, for example, graphics, icons, letters, characters, symbols, and/or functions. The indicia also may be user defined, for example. In one embodiment, the indicia may comprise characters and/or symbols similar to the characters and/or symbols found in conventional keyboards. The indicia may also comprise information pulled or dynamically updated from other software applications or connected services such as, but not limited to, buddy lists, email contacts, cell phone books, device locations, and so forth. The indicia may also be company or content brands and/or third party trademarked or copyrighted materials. This allows indicia to be pulled from a varied set of information provided by existing applications and/or services which would allow the text entry to be familiar, graphically recognizable and efficient. The various embodiments described herein, however, are not limited in the context of the embodiment illustrated herein, as the indicia on the virtual keys may represent any predefined character, symbol, modifier, control, alternative, function, or shift keys. In an embodiment of the invention, menu selections may be expandable. Additionally, each selection may represent any variable information. This selection information may be dynamic, adjustable and considered to be independent from any of the other menu and/or menu selection. For example, one or more virtual keys may be added, deleted or changed without affecting any other menu or menu selection. Selection information may also be pulled from one or more independent servers or IP services without affecting the consumer experience or the appearance of user interface 100 and/or menus described herein. This consumer experience may be, for example, a “living room experience” via a television or a “mobile experience” via any handheld or mobile device such as an ultra mobile PC or the device described below with reference to FIG. 7.

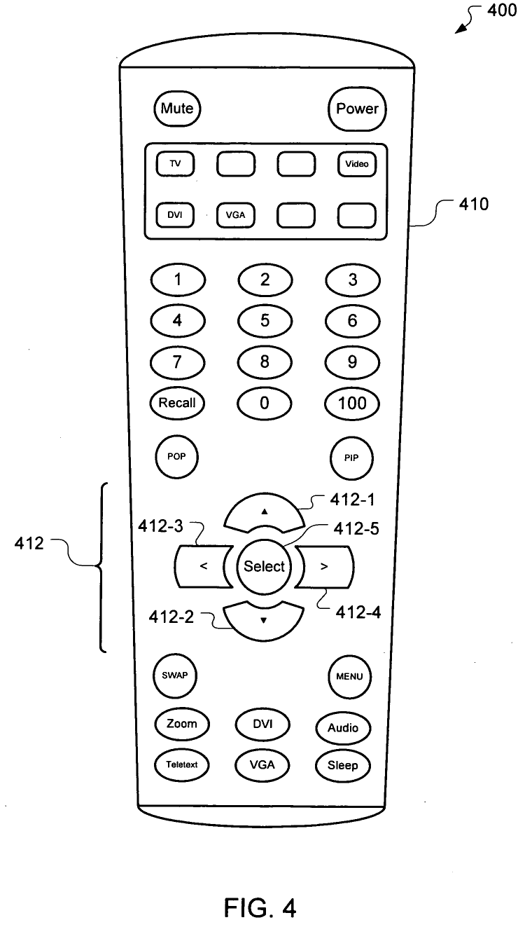

The virtual keys of menus 110 and 202 may be activated by a user via a navigation controller. In one embodiment, the navigation controller may be a pointing device or remote control, as described with reference to FIG. 4. Referring to FIG. 4, one embodiment of a navigation controller 400 is shown. In one embodiment, navigation controller 400 may be a pointing device 410 that may be used to activate one or more keys of navigation section 104 (FIG. 1) and DRM license menu 202 (FIG. 2). Pointing device 410 may be any computer hardware component (specifically human interface device) that allows a user to input spatial (i.e., continuous and multi-dimensional) data into a computer. Many systems such as computer aided design (CAD), graphical user interfaces (GUI), and televisions and monitors allow the user to control and provide data to the computer or television using physical gestures—point, click, and drag—typically by moving wired or wireless pointing device such as a mouse, trackball, touchpad, pointing stick, light pen, joystick, head pointer, eye tracking device, digitizing tablet, data glove, remote controller, among others. Movements of pointing device 410 are echoed on a display device by movements of a pointer, cursor, focus ring, or other visual indicators displayed on the display device.

In the illustrated embodiment, pointing device 410 is a conventional remote control unit used to interact with audio/visual devices such as televisions, monitors, cable boxes, digital video disc (DVD) player, compact disc (CD) players, digital video recorders (DVR), video games, digital video camera, and/or digital still camera, among others, for example. Pointing device 410 comprises navigation buttons 412. In one embodiment, the navigation buttons 412 comprise an upward navigation button 412-1, a downward navigation button 412-2, a leftward navigation button 412-3, and a rightward navigation button 412-4. Navigation buttons 412 also may comprise a select button 412-5 to execute a particular function. Pointing device 410 may be a wireless remote that operates on wireless principles employing infra-red (IR) energy or radio frequency (RF) energy. In other embodiments, pointing device 410 may be hard wired to the display device, for example. The embodiments, however, are not limited to the elements or in the context shown or described in FIG. 4.

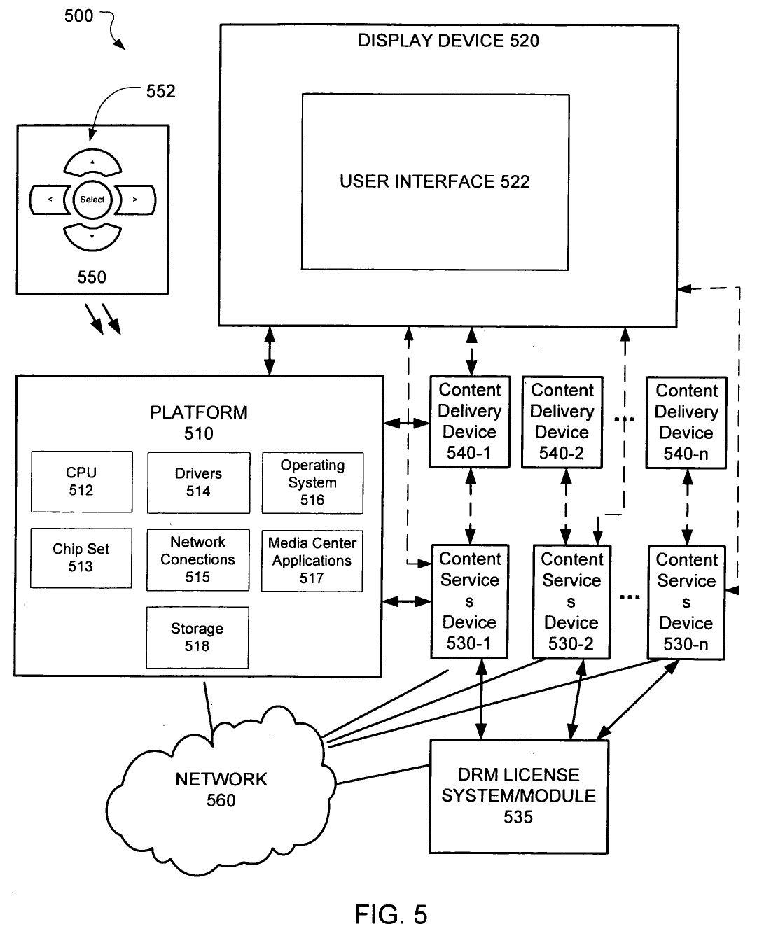

FIG. 5 illustrates one embodiment of a system 500. In one embodiment, system 500 may be a digital home entertainment system although system 500 is not limited in this context. In one embodiment, system 500 comprises a platform 510 coupled to a display device 520. In one embodiment, platform 510 may comprise or may be implemented as a media platform such as the Viiv™ media platform made by Intel® Corporation. In one embodiment, platform 510 may receive content from one or more content devices such as content services devices 530 (530-1 to 530-n) or one or more content delivery devices 540 (540-1 to 540-n) or other similar content source. In an embodiment of the invention, one or more of content services devices 530 may be hosted by any national, international and/or independent service and thus accessible to platform 510 via the Internet. One or more of content services devices 530 may be coupled to platform 510 and/or to display device 520. Platform 510 and/or content services devices 530 may be coupled to a network 560 to communicate (e.g., send and/or receive) media information to and from network 560. One or more of content delivery devices 540 also may be coupled to platform 510 and/or to display device 520.

In various embodiments, one or more of content services devices 530 may be coupled (e.g., either directly or via network 560) to a DRM license system/module 535. Content and/or service providers may utilize one or more of content services devices 530 to provide services and/or products to a user via user interface 522 (or via user interface 100 in FIG. 1). The content and/or service providers may utilize DRM license system/module 535 to set up required and customized fields to manage digital rights to one or more of their products or services.

In various embodiments, platform 510 and one or more of content services devices 530 may be integrated, or platform 510 and one or more of content delivery devices 540 may integrated, or platform 510, one or more of content services devices 530, and one or more of content delivery devices 540 may be integrated, for example. In various embodiments, platform 510 and display device 520 may be an integrated unit and display device, or one or more of content service devices 530 may be integrated, or display device 520 and one or more of content delivery devices 540 may integrated. A navigation controller 550 comprising one or more navigation buttons 552 may be used to interact with either platform 510 or display device 520, and/ or both, for example.

In one embodiment, platform 510 may comprise a CPU 512, a chip set 513, one or more drivers 514, one or more network connections 515, an operating system 516, and/or a media center application 517 comprising one or more software applications, for example. Platform 510 also may comprise storage 518. Storage 518 may include control and content data used to define one or more menus (e.g., CSP menu 110 of FIG. 1 and DRM license menu 202 of FIG. 2), and so forth. In an embodiment, products of one or more content and/or service providers that are currently or previously licensed to the user may also be stored locally in storage 518. In an embodiment, menus 110 and 202 are fed via dynamic feed (e.g., metadata, external XML strings, and so forth, stored in storage 518). Storage 518 may also include the control and content data displayed in video/picture section 106 and descriptor section 108, as described above in FIG. 1.

In one embodiment, CPU 512 may comprise one or more processors such as dual-core processors. Examples of dual-core processors include the Pentium® D processor and the Pentium® processor Extreme Edition both made by Intel® Corporation, which may be referred to as the Intel Core Duo processors, for example.

In one embodiment, chip set 513 may comprise any one of or all of the Intel® 945 Express Chipset family, the Intel® 955X Express Chipset, Intel® 975X Express Chipset family, plus ICH7-DH or ICH7-MDH controller hubs, which all are made by Intel® Corporation.

In one embodiment, drivers 514 may comprise the Quick Resume Technology Drivers made by Intel® to enable users to instantly turn on and off platform 510 like a television with the touch of a button after initial boot-up, when enabled, for example. In addition, chip set 513 may comprise hardware and/or software support for 5.1 surround sound audio and/or high definition 7.1 surround sound audio, for example. Drivers 514 may include a graphics driver for integrated graphics platforms. In one embodiment, the graphics driver may comprise a peripheral component interconnect (PCI) Express graphics card.

In one embodiment, network connections 515 may comprise the PRO/1000 PM or PRO/100 VE/VM network connection, both made by Intel® Corporation.

In one embodiment, operating system 516 may comprise the Windows® XP Media Center made by Microsoft® Corporation. In one embodiment, one or more media center applications 517 may comprise a media shell to enable users to interact with content using navigation controller 550 (e.g., remote control) from a distance of about 10-feet away from platform 510 or display device 520, for example. In one embodiment, the media shell may be referred to as a “10-feet user interface,” for example. In addition, one or more media center applications 517 may comprise the Quick Resume Technology made by Intel®, which allows instant on/off functionality and may allow platform 510 to stream content to media adaptors or other content services devices 530 or content delivery devices 540 when the platform is turned “off.”

In one embodiment, storage 518 may comprise the Matrix Storage technology made by Intel® to increase the storage performance enhanced protection for valuable digital media when multiple hard drives are included, for example.

In one embodiment, display device 520 may comprise any television type monitor or display. Display device 520 may comprise, for example, a computer display screen, video monitor, television-like device, and/or a television. Display device 520 may be digital and/or analog.

In various embodiments, one or more of content services devices 530 may comprise a cable television box, personal computer, network, telephone, Internet enabled devices or appliance capable of delivering digital information and/or content, and any other similar device capable of unidirectionally or bidirectionally communicating content between content providers and platform 510 and/display device 520, via network 560. It will be appreciated that the content may be communicated unidirectionally and/or bidirectionally to and from any one of the components in system 500 and a content provider via network 560. Examples of content may include any media information including, for example, video, music, and gaming information. One or more of content services devices 530 may receive content such as cable television programming including media information, digital information, and/or other content. Examples of content providers may include any cable or satellite television or radio content providers and may include, for example, ESPN, Movielink, and MTV Overdrive for video; Napster, AOL and Tiscali for music; Gametap, Square Enix and T-Online for gaming; and YouTube and Flickr for sharing services.

In various embodiments, one or more of content delivery devices 540 may comprise a DVD player, CD player, DVR, video game, digital video camera, digital still camera, and/or MP3 (MPEG-1 Audio Layer 3 where MPEG stands for Moving Pictures Experts Group) player, among others, for example.

Platform 510 may receive content from network 560 directly or via one or more of content services devices 530. Platform 510 may receive content from one or more of content delivery devices 540. Under the control of one or more software applications, such as media center application 517, platform 510 displays user interface 522 (e.g., user interface 100) on display device 520.

In one embodiment, platform 510 may receive control signals from navigation controller 550 (e.g., navigation controller 400 of FIG. 4). Navigation buttons 552 (e.g., navigation buttons 412 of FIG. 4) may be used to interact with user interface 522. For example, under the control of software applications, e.g., media center applications 517, navigation buttons 552 located on navigation controller 550 may be mapped to the virtual navigation keys of navigation section 104 (FIG. 1).

In various embodiments, system 500 may be implemented as a wireless system, a wired system, or a combination of both. When implemented as a wireless system, system 500 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 500 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 510 may establish one or more logical or physical channels to communicate information. The information may include media information and control information. Media information may refer to any data representing content meant for a user. Examples of content may include, for example, data from a voice conversation, video conference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 5.

As discussed above, content and/or service providers may utilize DRM license system/module 535 to set up required and customized fields to request and/or manage licenses to products from a user via DRM license menu 202 (FIG. 2). This allows for multiple content and/or service providers to aggregate multiple processes that are necessary for a worldwide content and services digital rights management system into a single architecture and business process. Here, the user or consumer's experience is kept fairly consistent regardless of the content and/or service providers' desired data from the user. This consumer experience may be, for example, a “living room experience” via a television or a “mobile experience” via any handheld or mobile device such as an ultra mobile PC or the device described below with reference to FIG. 7.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof.

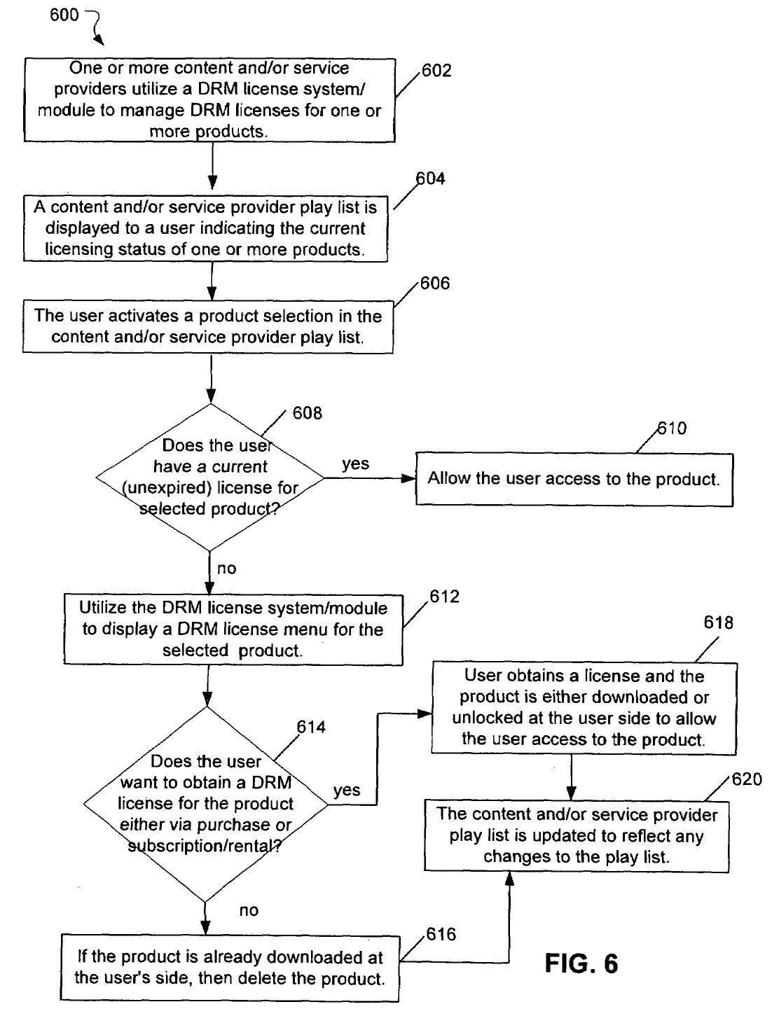

FIG. 6 illustrates one embodiment of a logic flow 600. The logic flow 600 may be representative of the operations executed by one or more embodiments described herein, for example, the operations executed by system 500. In one embodiment, logic flow 600 may be representative of the operations executed by a processor (e.g., the CPU 512) under the control of one more software applications (e.g., media center applications 517). Platform 510 comprising processor 512 provides the necessary information to display device 520 to map user interface 522 on display device 520.

As shown in logic flow 600, at block 602, one or more content and/or service providers utilize a DRM license system/module (such as system/module 535 of FIG. 5) to set up required and/or customized fields to manage licenses for one or more products. As described above, this allows for multiple content and/or service providers to manage DRM licenses for a worldwide content and services delivery system into a single architecture and business process.

At block 604, a content and/or service provider play list (such as CSP menu 110 of FIG. 1) is displayed to a user indicating the current licensing status of one or more products. A product may be anything offered to a user, including but not limited to, various services and/or content, shows/programs/movies, voice, audio, music, graphics, video games, books, customer lists, and so forth. The user, at block 606, may activate a product selection in the play list.

At block 608, it is determined whether the user has a current, unexpired DRM license for the selected product. If yes, then at block 610 the user is allowed access to the product. If not, then the DRM license system/module is used to display a DRM license menu (such as menu 202 of FIG. 2) for the selected product, at block 612.

At block 614, it is determined whether the user wants to obtain a DRM license for the selected product either via purchase or subscription/rental. If yes, the user is allowed to obtain a license. Then, the product is either downloaded to the user side (if a license was not obtained previously) or unlocked (if a license was obtained previously and unexpired) to allow the user access to the product, at block 618. If no, then if the product was previously downloaded at the user side, then the product is deleted (if determined by the content and/or service provider), at block 616. Here, the user is denied access to the product. At block 620, the content and/or service provider play list is updated to reflect any changes to the play list (e.g., obtained license and/or deleted product). The embodiments, however, are not limited to the elements or in the context shown or described in FIG. 6.

FIG. 7 illustrates one embodiment of a device 700. In one embodiment, for example, device 700 may comprise a communication system. In various embodiments, device 700 may comprise a processing system, computing system, mobile computing system, mobile computing device, mobile wireless device, computer, computer platform, computer system, computer sub-system, server, workstation, terminal, personal computer (PC), laptop computer, ultra-laptop computer, portable computer, handheld computer, personal digital assistant (PDA), cellular telephone, combination cellular telephone/PDA, smart phone, pager, one-way pager, two-way pager, messaging device, and so forth. The embodiments are not limited in this context.

In one embodiment, device 700 may be implemented as part of a wired communication system, a wireless communication system, or a combination of both. In one embodiment, for example, device 700 may be implemented as a mobile computing device having wireless capabilities. A mobile computing device may refer to any device having a processing system and a mobile power source or supply, such as one or more batteries, for example. Examples of a mobile computing device may include a laptop computer, ultra-laptop computer, portable computer, handheld computer, palmtop computer, personal digital assistant (PDA), cellular telephone, combination cellular telephone/PDA, smart phone, pager, one-way pager, two-way pager, messaging device, data communication device, and so forth. Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In one embodiment, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 7, device 700 may comprise a housing 702, a display 704, an input/output (I/O) device 706, and an antenna 708. Device 700 also may comprise a five-way navigation button 712. I/O device 706 may comprise a suitable keyboard, a microphone, and/or a speaker, for example. Display 704 may comprise any suitable display unit for displaying information appropriate for a mobile computing device. I/O device 706 may comprise any suitable I/O device for entering information into a mobile computing device. Examples for I/O device 706 may include an alphanumeric keyboard, a numeric keypad, a touch pad, input keys, buttons, switches, rocker switches, voice recognition device and software, and so forth. Information also may be entered into device 700 by way of microphone. Such information may be digitized by a voice recognition device. The embodiments are not limited in this context.

Device 700 may comprise a user interface 710 that may be displayed on display 704 similar to user interface 100 discussed herein.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus, comprising:
a processor to receive a control signal from a navigation controller and to display a user interface on a display device, wherein the user interface includes a menu having one or more menu selections provided by a content and/or service provider for the management of digital rights managed (DRM) licenses, wherein each of the one or more menu selections represents a product offered to a user at a user side, wherein the menu includes a current license status for each of the products, and based on the control signal the processor to activate one of the one or more menu selections to display a DRM license menu if a license is required for the product of the activated menu selection, and the processor to store the product of the activated menu selection at the user side if a license is obtained by the user.

2. The apparatus of claim 1, further comprising the processor to determine when the obtained license expires and to lock access to the product at the user side with the expired license.

3. The apparatus of claim 2, unlocking access to the product at the user side with the expired license once the user renews the expired license.

4. The apparatus of claim 1, wherein the navigation controller is a remote control device.

5. The apparatus of claim 1, wherein the display of the one or more menu selections is updated on the user interface when the current license status of any of the products is changed.

6. The apparatus of claim 1, wherein the display device is a television.

7. The apparatus of claim 1, wherein the display device is a mobile device.

8. A method, comprising:
displaying a user interface on a display device, wherein the user interface includes a menu having one or more menu selections provided by a content and/or service provider for the management of digital rights managed (DRM) licenses, wherein each of the one or more menu selections represents a product offered to a user at a user side, wherein the menu includes a current license status for each of the products;
activating one of the one or more menu selections to display a DRM license menu if a license is required for the product of the activated menu selection; and
storing the product of the activated menu selection at the user side if a license is obtained by the user.

9. The method of claim 8, further comprising:
determining when the obtained license expires; and
locking access to the product at the user side with the expired license.

10. The method of claim 9, further comprising:
unlocking access to the product at the user side with the expired license once the user renews the expired license.

11. The method of claim 8, wherein the navigation controller is a remote control device.

12. The method of claim 8, further comprising:
updating the display of the one or more menu selections on the user interface when the current license status of any of the products is changed.

13. The method of claim 8, wherein the display device is a television.

14. The method of claim 8, wherein the display device is a mobile device.

15. A system, comprising:
a content device; and
a processor to receive a control signal from a navigation controller and to display a user interface on a display device, wherein the user interface includes a menu having one or more menu selections provided by a content and/or service provider for the management of digital rights managed (DRM) licenses, wherein each of the one or more menu selections represents a product offered to a user at a user side, wherein the menu includes a current license status for each of the products, and based on the control signal the processor to activate one of the one or more menu selections to display a DRM license menu if a license is required for the product of the activated menu selection, and the processor to store the product of the activated menu selection at the user side if a license is obtained by the user.

16. The system of claim 15, further comprising the processor to determine when the obtained license expires and to lock access to the product at the user side with the expired license.

17. The system of claim 16, unlocking access to the product at the user side with the expired license once the user renews the expired license.

18. The system of claim 15, wherein the navigation controller is a remote control device.

19. The system of claim 15, wherein the display of the one or more menu selections is updated on the user interface when the current license status of any of the products is changed.

20. The system of claim 15, wherein the display device is a television.

21. The system of claim 15, wherein the display device is a mobile device.

22. A machine-readable medium containing instructions which, when executed by a processing system, cause the processing system to perform a method, the method comprising:
displaying a user interface on a display device, wherein the user interface includes a menu having one or more menu selections provided by a content and/or service provider for the management of digital rights managed (DRM) licenses, wherein each of the one or more menu selections represents a product offered to a user at a user side, wherein the menu includes a current license status for each of the products;
activating one of the one or more menu selections to display a DRM license menu if a license is required for the product of the activated menu selection; and
storing the product of the activated menu selection at the user side if a license is obtained by the user.

23. The machine-readable medium of claim 22, further comprising:
determining when the obtained license expires; and
locking access to the product at the user side with the expired license.

24. The machine-readable medium of claim 23, further comprising:
unlocking access to the product at the user side with the expired license once the user renews the expired license.

25. The machine-readable medium of claim 23, wherein the navigation controller is a remote control device.

26. The machine-readable medium of claim 23, further comprising:
updating the display of the one or more menu selections on the user interface when the current license status of any of the products is changed.

27. The machine-readable medium of claim 23, wherein the display device is a television.

28. The machine-readable medium of claim 23, wherein the display device is a mobile device.
